(19) United States
(12) Patent Application Publication
(10) Pub. No.: US 2007/0280507 A1
(43) Pub. Date: Dec. 6, 2007

(54) Apparatus and Upwind Methods for Optical Flow Velocity Estimation

(76) Inventor: Beddhu Murali, Petal, MS (US)

Correspondence Address: BEDDHU MURALI, PHD, 7 SILVER MAPLE TRAIL, PETAL, MS, 39465-4176, US

(21) Appl. No.: 11/421,479

(22) Filed: Jun. 1, 2006

(51) Int. Cl. G06K 9/00

(52) U.S. Cl. 382/107

(57) ABSTRACT

Apparatus and methods for estimating the optical flow velocity components using an upwind discretization are presented. In prior art, the knowledge of the signs of the optical flow velocity components is needed for using upwind discretization. But in optical flow computations the velocity components are precisely the unknowns and thus their sign information is not available. This invention discloses apparatus and methods in which upwinding is done based on the sign of the local time derivative instead of the signs of the optical flow velocity components.

### BACKGROUND OF THE INVENTION

1. Technical Field

This invention relates to fields such as computer vision, medical imaging (PET, CT, MRI, tagged MRI, fMRI, ultrasound, infrared, X-ray, UV/visible light fluorescence, Raman spectroscopy or microwave), hyperspectral imaging, Doppler radar, and related fields where estimation of either 1D or 2D or 3D optical flow velocity components or the range flow velocity components is of interest. Specifically, embodiments of this invention include methods, apparatus, computer software implementations and computer hardware implementations suitable for computing optical flow velocity components involving one or more spatial dimensions. In the case of 2D, the optical flow may be observed on a Euclidian (flat) or a Riemannian (curved) image surface. The methods apply to both grey scale and color images. One can further process such estimated optical flow velocity components to recover other information of interest such as, but not limited to, 3D structure recovery, 3D motion recovery, image segmentation and image compression.

2. Description of Related Art

It is noted here that throughout this specification, reference to various individual prior art publications are indicated using a reference identifier which is an integer that is unique to each publication placed within a pair of square brackets. The names of the authors are cited along with the reference identifier when the prior art is mentioned for the first time. An example for this convention would be Horn and Schunck [1]. Any subsequent reference to the same publication may simply include the reference identifier ([1], for example) or may include the name(s) and the reference identifier (Horn and Schunck [1], for example). A group of publications is referred to either as Ref. [1, 3, 6], for example, or as Ref. [1-10], for example, as needed. The convention Ref. [1-10] implies a range of publications from [1] through [10], including [1] and [10]. In citing the names of the authors of the publications, the following convention is used: If there is three or less number of authors, then all their names are cited. If there are more than three authors to a publication then the name of the first author is cited followed by the phrase et al. A complete listing of all the references including the names of all the authors is included at the end of the Detailed Description Section.

For more than twenty-five years, optical flow velocity estimates have been computed using methods that use central differencing stencils to compute the components of the spatial gradient vector of the image intensity field. For example, Horn and Schunck [1] use an average of four two-point central differencing stencil along each coordinate direction that is centered at the common corner between eight neighboring pixels in two consecutive frames. Barron, Fleet and Beauchemin [2] use a five-point central differencing stencil in each coordinate direction, with mask coefficients

$$\frac{1}{12} [ - 180 - 81 ] .$$

### Recently, Bruhn, Weickert and Schnörr [3] have used a seven-point central differencing stencil in each coordinate direction, with mask coefficients

$$\frac{1}{60} [ - 19 - 45 \; 0 \; 45 - 91 ] .$$

Other popular central differencing based schemes for computing the image intensity derivatives include the Sobel scheme [4], the Prewitt scheme [5] and the scheme based on Gaussian and derivative of Gaussian kernels. The Gaussian kernel based scheme is especially popular in obtaining the intensity derivatives when one assumes that the intensity field is corrupted by Gaussian noise.

Barron, Fleet and Beauchemin [2] also implement the Lucas-Kanade [6] scheme using the same five-point central differencing stencil mentioned above. Bruhn, Weickert and Schnörr [3] use the seven point stencil in their implementation of the Lukas-Kanade algorithm.

In U.S. Pat. No. 6,480,615, Sun and Kim [7] disclose a method of adaptively calculating the spatial and temporal derivatives using a suitably defined occlusion detection parameter S. The adaptivity comes from the fact that they either use current (k) and next frame (k+1) or use the current (k) and the previous frame (k−1) in order to calculate the spatial and temporal derivatives using the Horn and Schunck scheme. Note that the Horn and Schunck scheme always uses the current (k) and the next (k+1) frames. They also approximate the temporal derivative using a Sobel-based approximation involving the frames k−1, k and k+1. Thus, the adaptive gradients approach of Sun et al still uses central differencing based approximations to compute image gradients.

Since the optical flow constraint is hyperbolic in nature, it is well known in hyperbolic solver prior art that, in general, central differencing based methods are either numerically oscillatory or outright unstable unless one explicitly adds stabilizing terms in the discretization process.

Though such oscillatory behavior has been noted in the optical flow and computer vision literature also, especially near image and motion discontinuities, the current state-of-the-art in these literatures identifies such oscillatory behavior as outlier (in a statistical sense), which has led to the application and development of the so-called robust estimation techniques. In the Horn and Schunck [1] method, for example, such oscillations are evident at low values of the smoothing parameter.

Black and Anandan [8], for example, consider a synthetic case where the left half of an image (with a smoothly varying, but randomly distributed, intensity field) is stationary and the right half moves by one pixel. In other words, their case had a discontinuity in the horizontal optical flow velocity component along the vertical line in the middle of the image. Following their analysis of this case, they conclude on page 81 “ . . . even in this synthetic example, with no added noise, violations of the data conservation constraint, (Iₓu+I_{y}v+Iₜ=0), occur at the motion boundary.” Without examining the cause for these model violations, they say on page 82, “Model violations such as these result in measurements that can be viewed in a statistical context as outliers.” Following this statement they introduce their robust estimation method.

Robust estimation based methods such as that of Black and Anandan [8] essentially compute a numerically-induced oscillatory solution first and then use truncated norms to limit the impact of these numerical oscillations. In contrast, the hyperbolic solver literature has developed alternate numerical schemes such as upwind schemes, which feature built-in numerical dissipation, in order to eliminate the numerical oscillations, especially near discontinuities. While robust estimation techniques are not the appropriate techniques for dealing with numerical oscillations caused by discretization techniques one happens to use, their use might still be appropriate in order to deal with truly random error sources after one uses consistent and stable numerical schemes for discretizing the optical flow constraint.

Though upwind methods for solving hyperbolic equations are stable and produce oscillation-free solutions near discontinuities, they do require the knowledge of the sign of the velocity components in order to properly choose the upwind direction. Since the optical flow velocity components are precisely the unknowns, one does not possess the knowledge of their sign a priori. Thus, how to develop an upwind discretization of the optical flow constraint is not obvious.

Borzi, Ito and Kunisch [9] first use the standard Horn and Schunck [1] method to compute an initial estimate of the optical flow velocity vector. They next use this optical flow velocity vector and compute an updated numerical intensity field, again using the optical flow constraint, this time employing an upwind scheme. Then they use an iterative procedure involving a so-called adjoint optical flow constraint and a couple of elliptic equations to minimize the difference between the numerical intensity field and the intensity field obtained by the camera. Note that they do not use the upwind formulation of the optical flow constraint to first obtain the optical velocity components. So, as discussed above, their initial velocity field will be error prone since they use the standard Horn and Schunck method to obtain it. Since they use this velocity field to upwind the optical flow constraint later to obtain a numerical intensity field, the upwind direction will be error prone. Moreover, they do not use any robust estimation technique either. Thus, their approach does not prevent numerically induced oscillatory solutions.

Sakaino [10] uses optical flow computations for predicting weather radar patterns. He assumes that intensity varies linearly along characteristic lines, an idea originally suggested by Gennert and Nagahdaripour [11], and introduces two additional parameters to be estimated in addition to the optical flow velocity components. Then he solves for all these parameters in a traditional lease squares setting using central differences for the spatial derivatives of the intensity field. He also uses a Lorentzian robust estimator following Black and Anandan [8]. After computing the optical flow velocity components using this approach, he uses an upwind scheme based on these velocity components and again solves the optical flow constraint in order to predict the expected image intensity field in the next instant in time. Since Sakaino [10] uses central differences to compute the optical flow velocity components in the first place, his approach suffers the same drawbacks as that of Borzi, Ito and Kunisch [9].

Zientara et al [12] use 2D optical flow field to predict the dynamics of tissue changes during thermal ablations by a laser using MRI data. Prince, Gupta and Osman [13] use optical flow computations to compute cardiac motion using tagged MRI data. They use a Fourier decomposition of the cardiac data to extract subbands and apply the optical flow constraint for each subband. Srikanth and Ramakrishnan [14] use optical flow estimates in developing a mesh based compression algorithm for MRI data. A 3D version of the Lukas-Kanade algorithm is used by Abramoff and Viergever [15] to predict 3D soft-tissue motion using 3D optical flow. Using Simoncelli's [16] five-point balanced kernels for obtaining spatial image intensity derivatives, which again is a central differencing scheme, Barron [17] computes the 3D optical flow for predicting heart motion using gated MRI cardiac datasets. Golland and Bruckstein [18] have extended the application optical flow constraint to color images by applying the constraint to the three colors, red green and blue, for example, independently. In short, there are several fields where 2D or 3D optical flow computations are routinely used. However, in all these studies so far, upwind methods are not used for computing the optical flow velocity components themselves. This is a serious drawback since these state-of-the-art techniques introduce spurious oscillations and corrupt the computations of optical flow velocity components.

### SUMMARY OF INVENTION

This invention presents systems and methods for computing optical flow velocity components using an upwind discretization, where upwinding is performed based on the sign of the local time derivative in the optical flow constraint.

A system typically comprises of a field sensing device that records spatio-temporal distribution of either an electromagnetic field or a mechanical/acoustic field of interest on a suitable sensitive medium, an optical flow computing device, means of connecting the two types of devices, means of transferring data between the two types of devices, a device to store the data generated by the two types of devices, and means of communicating between the two types of devices. Exemplar field sensing devices would comprise of a camera, which generates a 2D field at each instant in time, and an MRI, which generates a 3D field at each instant in time. In this specification the word camera is used to mean any field sensing device, i.e., both 2D and 3D devices. Data produced by a camera at an instant in time is called an image. An exemplar optical flow computing device would be a computer.

Since it is possible to first store images captured by the camera using a storage device and analyze them later by an optical flow computing device, the presence of a physical camera as part of the system is not mandatory at the time optical flow computations are performed. In other words, the camera can be considered or abstracted to be virtually present. The presence or absence of a physical camera as part of the system depends on the intended application of the methods of this specification. Extending the concept of the virtual camera, the upwind optical flow computing methods of this invention can also be applied to synthetic images generated by a computer. Alternately, images can first be scanned into a computer, in which case the scanner plays the role of a camera.

The system runs an implementation, called the optical flow compute (OFC) module, of one or more of the methods of this invention, on the optical flow computing device. The OFC module receives at least two images as input, one typically recorded at t=tⁿ and the other recorded at a slightly later time, say t=tⁿ⁺¹, where t is time, tⁿ is a particular instant in time, and n is an integer. Then the OFC module computes the optical flow velocity components between the two images. If the images at tⁿ and tⁿ⁺¹ are used to compute the optical flow velocity components at tⁿ then the method is an explicit scheme. On the other hand, if the same two images are used to compute the optical flow velocity components at tⁿ⁺¹ then the method is implicit.

Images are supplied to the OFC module by an input-output (IO) module. The IO module either receives the images from the camera or computer (for computer generated images) or reads them from the storage media.

For processing an input stream of images, the system runs the OFC module in a loop, which then computes the optical flow velocity components for every successive image pairs by incrementing n. The input stream to the OFC module can be a sub-stream of the images generated by a camera or generated by a computer or read from storage.

Data transfer and data storage in the system may optionally involve data compression, in which case, data will be decompressed by a data decompression module before the OFC module computes the optical flow velocity components.

The OFC module computes the local time derivative at each pixel (i, j) by Iᵢⱼⁿ⁺¹−Iᵢⱼⁿ, where I is the image intensity field. Then the OFC module determines whether this time derivative is positive or negative.

If \vec{u} is the optical flow velocity vector and \vec{n} is the unit normal along the direction of the gradient vector of the image intensity field then the normal optical flow speed F is defined to be F=\vec{u}·\vec{n}. According to the invention disclosed in this specification, a negative local time derivative corresponds to a positive normal optical flow speed and a positive local time derivative corresponds to a negative normal optical flow speed. Thus, if the local time derivative of the image intensity field is positive at a pixel then F is negative at that pixel and vice versa. Thus, even though the optical flow velocity components are not known, the OFC module determines the sign of the speed function F to be the negative of the sign of the local time derivative.

After determining sign of the speed function, the OFC module calculates the spatial derivatives appearing in the optical flow constraint in a manner analogous to the level set method. The only difference is that the level set method calculates the squares of the image derivatives, whereas the present invention discloses how to calculate the actual derivatives themselves and not just their squares. The actual values of the image derivatives are needed in several prior art optical flow velocity computing techniques.

Finally, in order to compute the optical flow velocity components, the OFC module uses the upwind image derivatives calculated as disclosed above, instead of calculating them using central differencing stencils, in methods such as, but not limited to, the Horn and Schunck method and the Lukas-Kanade method. Thus, several upwind optical flow methods become available.

The OFC module uses one or more of the above disclosed upwind methods to calculate the optical flow velocity components regardless of whether the optical flow is 1D or 2D or 3D or whether the images are color or grayscale. It uses the same methods for calculating the velocity components in range flow problems.

The upwind methods for 1D, 2D and 3D, grayscale or color, optical flow computations as well as range flow computations need not be implemented in a single module. They can be implemented, optimized, and used separately. Indeed, this is a preferred embodiment of this specification. Obviously, a 3D OFC module can be used for solving a 1D or 2D problem if resource utilization and performance are not of concern.

It is an object of this specification to use the system disclosed in this specification to generate 2D, color or grayscale, images using a camera and use them to compute the optical flow velocity components in real-time or near real-time.

It is an object of this specification to use the system disclosed in this specification to generate 3D or range, color or grayscale, images using a camera and use them to compute the optical flow velocity components in real-time or near real-time.

It is an object of this specification to use the system disclosed in this specification to generate 2D, synthetic, color or grayscale, images and use them to compute the optical flow velocity components.

It is an object of this specification to use the system disclosed in this specification to generate 3D or range, synthetic, color or grayscale, images and use them to compute the optical flow velocity components.

It is an object of this specification to use the system disclosed in this specification to read previously stored 2D or 3D or range, color or grayscale, images to compute the optical flow velocity components.

It is an object of this specification to provide the computed optical flow velocity components to other modules for further processing such as 3D structure recovery, 3D motion recovery, image segmentation, image compression, prediction of the image at the next instant in time and others.

### BRIEF DESCRIPTION OF DRAWINGS

In order to facilitate a better understanding of the particular features, aspects and benefits of the present invention the accompanying drawing are provided along with a detailed description and a set of claims. These drawing are:

FIG. 1 is block diagram showing an upwind optical flow computing system comprising of exemplary components for an implementation of the apparatus and methods of this invention.

FIG. 2 is a block diagram showing an exemplary field sensing device. It comprises of one or more cameras that may independently produce several image streams or collectively produce, possibly overlapping, pieces of a single image stream.

FIG. 3 is a block diagram illustrating an exemplary optical flow compute device. It comprises of one or more general or special purpose computers. Each computer may receive image streams from one or more cameras or part of an image produced by a single camera. The computers are typically networked. But this may not be necessary in certain applications.

FIG. 4 shows a block diagram of an exemplary general purpose computer that can be part of the optical flow compute device.

FIG. 5 shows two preferred embodiments of the present invention. In the first embodiment, a single camera is connected to a general purpose computer and in the second embodiment a single camera is connected to a special purpose computer. The connection is typically using wired components. But, wireless connections are also within scope.

FIG. 6 is a flow chart illustrating one embodiment of the process of upwind optical flow computation where the decision on how to upwind is based upon the sign of the local time derivative.

### DETAILED DESCRIPTION OF THE INVENTION

The following description presents preferred embodiments referring to the accompanying drawings which show specific embodiments that may be practiced, by way of illustration. These drawings are included heretofore as part of the description. It is clear, without departing from the scope of this specification, that other embodiments may also be practiced including structural changes made to the ones disclosed in this specification.

A system typically comprises of (1) a field sensing device that records a spatio-temporal distribution of an electromagnetic field or a mechanical/acoustic field, (2) a optical flow computing device that performs optical flow computations using upwind discretization-based image derivatives, (3) associated peripheral devices, and (4) internal and external interconnects that connect the field sensing device, the optical flow computing device and peripherals. In order to produce an optical flow, the system, either in whole or in part, may be stationary on the ground or be mounted on a mobile platform.

The present system and process use upwind methods to compute image derivatives which are further used to compute optical flow velocity components between two images produced at slightly different times by a field sensing device. Synthetic images produced using a computer or scanned into a computer may also be used in place of the images produced by the field sensing device. The system may be operated in a real-time mode or a non real-time mode. In the real-time mode, images produced by the field sensing device are immediately transferred to the computing device in real-time and computations are performed in real-time. Data can be transferred electronically (wired) and/or electromagnetically (wireless). In the non real-time mode, images produced by a field sensing device may first be stored on a storage device or medium and later be read by the computing device to perform the optical flow velocity computations. In this case, the field sensing device may physically be absent at the time the velocity components are actually computed. Regardless of how they were generated, images read from storage are regarded as images produced by a virtual camera for the purpose of optical flow velocity computations. The process of reading data from storage is called receiving data transferred from a virtual camera.

### 1.0 An Exemplar System

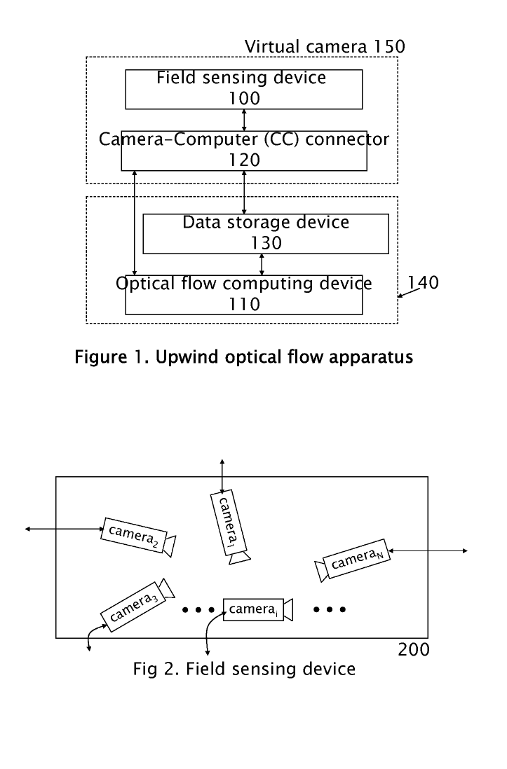

An exemplar system is shown in FIG. 1 using block diagrams and comprises of the following devices: A field sensing device 100 is connected to the optical flow computing device 110 using a camera-computer (CC) connector 120. An optional storage device 130 is also shown, where data generated by the field sensing device and the optical flow computing device can be stored. The storage device can either be external or be part of the optical flow computing device. External storage devices, if present, are abstracted as being part of the optical flow computing device. This is shown by the dotted box around these two devices 140.

A virtual camera 150 is indicated by the dotted box around the optical flow sensing device 100 and the camera-computer connector.

Exemplar field sensing devices comprise of a camera, which generates a 2D field at each instant in time, and an MRI, which generates a 3D field at each instant in time. In this specification the word camera is used to mean any field sensing device, i.e., both 2D and 3D devices. Data produced by such a camera at an instant in time is called an image. An expanded view of the field sensing device 200 is shown in FIG. 2, which shows that the field sensing device may be comprised of one or more cameras. All the cameras need not be of the same type. For example, one camera could be recording the visible band, while another one could be recording the infrared (IR) band of the electromagnetic spectrum.

Connections to the CC connector 210 are also shown in FIG. 2. These connectors can be wired or wireless or a mix of both. Exemplar wired or wireless connections comprise of Ethernet, fast Ethernet, Gigabit Ethernet, 10 Gigabit Ethernet, Cameralink, FireWire and USB (Universal Serial Bus).

Images produced by multiple cameras can either be regarded as independent image streams or their output can be combined to produce a single mosaicked image stream. A camera may simply record images and transfer them to other devices, or do further processing such smoothing and then transfer them to other devices. A camera may also store images internally for processing and/or transferring. Data recording and data transfer may occur at regular time intervals, which may or may not be adjustable, or on demand, say, using a trigger or a command. A camera may produce images in analog form. In such cases, the images will be converted using an analog-to-digital converter into digital images before they can be processed by a computer.

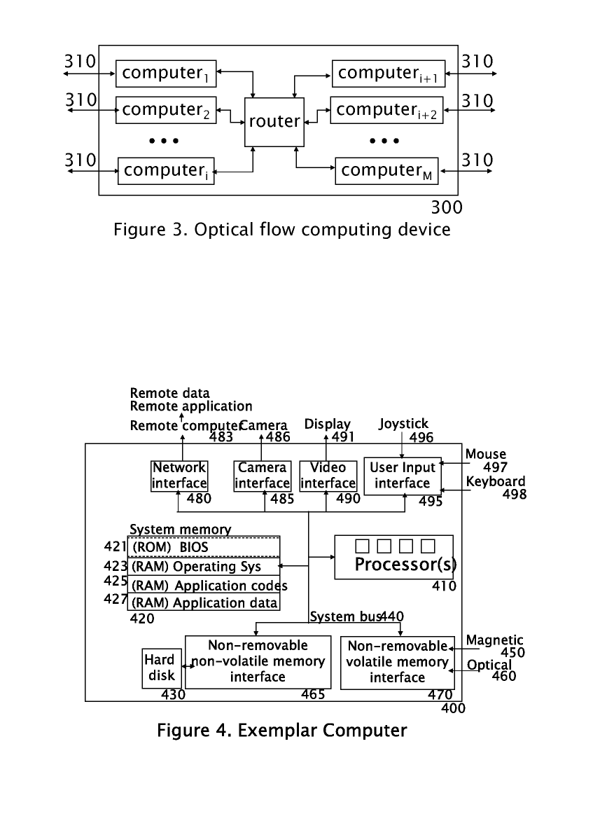

An expanded view of the optical flow computing device 300 is shown in FIG. 3, which shows that the optical flow computing device may comprise of one or more computers. If there are more than one computer, they can be homogeneous or heterogeneous, including special purpose computers, and they may or may not be interconnected or networked. Each computer may receive image streams from one or more cameras or part of an image produced by a single camera. The need for networking depends upon the intended application. For example, in the mosaicked image stream case, networking would be appropriate for this embodiment. In other words, when a computer receives part of an image stream then networking is necessary to communicate about the remaining parts of the image stream and for further processing. Connections to the CC device 310 are also shown in FIG. 3. These connectors can be electronic (wired) or electromagnetic (wireless) or a mix of both. Exemplar connections are the same as before. Multiple computers, if present, can be physically located in the vicinity of each other or can be widely distributed over a large space.

An exemplary computer 400 is shown in FIG. 4. This computer may comprise of one or more processors 410 and may have shared or distributed memory elements 420 among the processors. The processors may be central processing units (CPUs) and/or graphical processing units (GPUs). Both volatile (RAM) 423-427 and non-volatile (ROM) 421 memory are typically included. The well-known Basic Input Output System (BIOS), needed, for example, while starting the computer, is typically stored in ROM. Instructions and data needed by the processor for the intended functioning of the computer is typically stored in RAM. This could include operating system 425, optical flow compute (OFC) and other application program modules 426 and other programming modules, application 427 and other data.

The computer may further comprise of internal 430 or external 450, 460 or internal and external storage devices, where image streams, OFC module and other application modules, computed velocity components and other modules including the operating system are stored, as needed. Typically these devices are connected to the system bus using non-removable non-volatile memory interfaces 465 and non-removable volatile memory interfaces 470 respectively. Here, non-removable means not removable when the computer is operational without jeopardizing the computer and/or its operability. While the internal storage devices are typically non-removable, the external devices are typically removable. Storage devices are typically non-volatile. Program modules, program input and output data, other data, operating systems etc. are stored on the storage devices. Storage devices can comprise of (1) magnetic such as magnetic disk, magnetic tape and magnetic cassette, (2) optical such as CD or DVD, (3) memory technology based such as ROM, RAM, EEPROM, memory stick etc, or (4) any other medium for storing machine readable instructions and data. In a networked environment, it is possible that the computer may have no storage at all and operate in what is known as the diskless mode in which case, the necessary instructions and data for the start up and subsequent functioning for computing optical flow are exchanged using a suitable networking technology, such as Gigabit Ethernet.

The computer typically comprises of an internal interconnect called the system bus 440, which connects the processor(s) with memory, storage devices, and other peripheral devices. The system bus may include other buses such as memory bus, a memory controller, a peripheral bus and a local bus. Exemplar bus architectures include Peripheral Component Interconnect (PCI) bus, PCI Express bus, Industry Standard Architecture (ISA) bus, Enhanced Industry Standard Architecture (EISA) bus, Micro Channel Architecture (MCA) bus, and Video Electronics Standards Association (VESA) local bus. Peripheral devices are connected to the computer using individual peripheral interfaces 480, 485, 490, and 495. Exemplary peripheral devices that may be connected to the computer comprise of removable media 450, optical discs 460, removable memory, network devices (including framegrabbers), camera 486, display device 491, keyboard 498, joystick 496, game console, trackball, touchpad and mouse 497. User input is provided to the computer typically using one or more input devices, which comprise of keyboard, mouse, joystick, touchpad, trackball, and game console. User input may also be provided remotely 483 using the network devices. Computer response is typically seen by the user on the display device. Computer response may also be sent out to remote locations using the network devices. Exemplary external interconnects that may be connected to the computer would comprise of devices such as hubs, switches, and routers as well as the wired or wireless connections between them.

Structural changes such as, but not limited to, adding or removing one or more peripheral interfaces so as to connect a printer or a television or a USB mouse etc, using hot-swappable storage disks or peripheral devices, hot-swappable power supply, hot-swappable fan, etc are within the scope of this specification. Using other communication means such as, but not limited to, acoustic means are within the scope of this specification. Inclusion of the computer in networks such as, but not limited to, a LAN (Local Area Network) or WAN (Wide Area Network) or SAN (Storage Area Network) is also within scope.

The optical flow computing device could also comprise of special purpose devices that are based on ASIC (Application Specific Integrated Circuits), ASSP (Application Specific Standard Products), SOC (System on a Chip), SBC (Single Board Computer), FPGA (Field Programmable Gate Array), and/or other special purpose technologies. These technologies can be used on a stand alone basis or be integrated with or within a general purpose computer as in, but not limited to, using FPGA boards with a general purpose processor. Both approaches are within the scope of this specification.

### 2.0 Preferred Embodiments

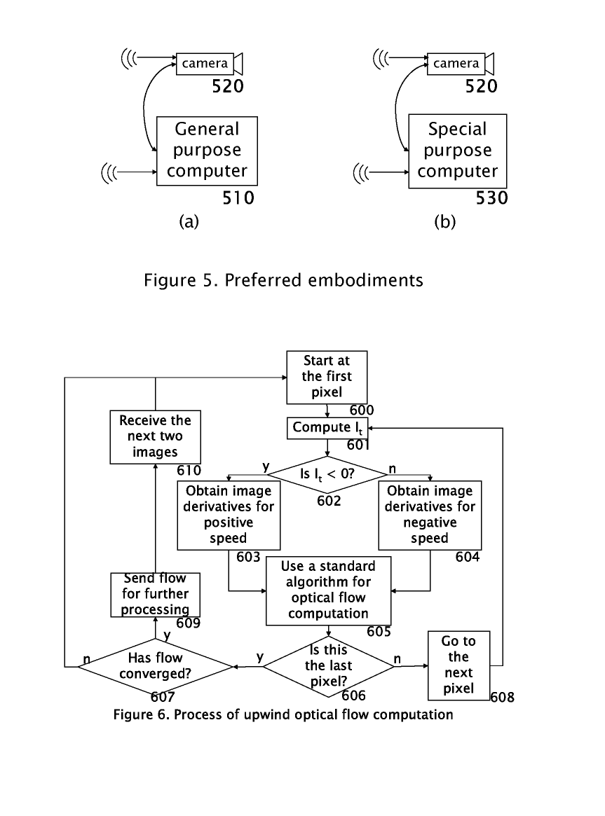

Two choices for a preferred embodiment are shown in FIG. 5. In both choices, a single camera 520 is directly connected to a single computer either using wired or wireless connections. While in FIG. 5(a) the computer 510 is a general purpose device 400 as shown in FIG. 4, in FIG. 5(b) the computer 530 is a special purpose device. In both cases, the computer receives images from the camera, calculates upwind discretization-based image derivatives and uses them in computing the optical flow velocity components and uses the computed optical flow in subsequent processing, which is application dependent.

### 3.0 Optical Flow Compute Module

In the first preferred embodiment, the methods of this invention are implemented using a programming language into a computer program that gets compiled and run on an optical flow computing device, which is a general purpose computer. In this disclosure, the term software implementation is used to refer to this type of implementation. In the second preferred embodiment, using a suitable programming language, the methods are compiled into netlists from which suitable photomasks are produced. Using these photomasks, suitable computer chips are fabricated. Alternately, using suitable place and route tools, the netlists are fitted to a FPGA architecture. In this disclosure, the term hardware implementation is used to refer to these types of implementations. The term implementation, when used alone, refers to either software or hardware or both implementations. The term optical flow compute (OFC) module is also used to refer to an implementation.

The OFC module receives at least two images as input, one typically recorded at t=tⁿ and the other recorded at a slightly later time, say t=tⁿ⁺¹, where t is time, tⁿ is a particular instant in time, and n is an integer that indexes time. The image corresponding to t=tⁿ is called the current image and the one corresponding to t=tⁿ⁺¹ is called the next image in this specification. After receiving the current and the next images, the module computes the optical flow velocity components between the two images. If the images at tⁿ and tⁿ⁺¹ are used to compute the optical flow velocity components at tⁿ then the method is an explicit scheme. On the other hand, if the same two images are used to compute the optical flow velocity components at tⁿ⁺¹ then the method is implicit.

Typically, the current and next images used by the OFC module would be two consecutive image frames produced by a camera. However, this is not required. What is required is that the two images be recorded at slightly different times from each other such that phenomena of interest are observable in both images. Note that occlusion in one image would appear as a disocclusion in the other. In other words, the same scene is visible at both times. When images are read from storage they can even be read in a time-reversed manner. Thus, it is not required that tⁿ⁺¹>tⁿ. When tⁿ⁺¹<tⁿ the optical flow would be the negative of the optical flow produced when tⁿ⁺¹>tⁿ.

Images may be supplied to the OFC module by an input-output (IO) module. The IO module may be a stand alone module or be part of the OFC module. The IO module either receives the images from the camera or computer (for computer generated images) or reads them from the storage media. In case the images are received from a camera and the camera sends images at a faster rate than they are consumed by the OFC module then the IO module or other components of the system may simply disregard frames that arrive between requests from the OFC module. On the other hand if the camera allows the rate of production to be controllable then either the IO module or another component of the system may optionally control it.

For processing an input stream of images received by the OFC module, the system runs the OFC module in a loop, which then computes the optical flow velocity components for every successive image pairs it receives. The input stream received by the OFC module may be a sub-stream of the images generated by a camera or generated by a computer or read from storage.

Data transfer and data storage in the system may optionally involve data compression, in which case, data will be decompressed by a data decompression module before the OFC module computes the optical flow velocity components. The data decompression module could be a stand alone module or be part of the IO module or the OFC module.

The methods of this invention disclose how to compute the components of the spatial gradient of the image intensity field, also called image derivatives, using an upwind discretization where the decision on how to upwind is based on the sign of the local time derivative. Typically, the spatial gradient is evaluated using Cartesian pixel coordinates. Alternate methods of evaluation include the use of orthogonal curvilinear coordinates, non-orthogonal curvilinear coordinates, integration along an arbitrary closed curve, and/or an unstructured grid. Suitable, analytical or numerical, coordinate transformations are used from pixel coordinates to any of these other coordinate systems.

The optical flow constraint can be written as

Iₜ+\vec{u}·\vec{n}|∇I|=0, (1)

where I is the image intensity, t is time, \vec{u} is the optical flow velocity vector, \vec{n} is the unit normal to isocontours of I, |.| is the vector magnitude operator, and ∇ is the gradient operator. Subscript notation is used for partial derivatives. Note that \vec{n}=∇I/|∇I|. Denoting F=\vec{u}·\vec{n}, where F is the optical flow speed in the direction of \vec{n}, Eq. (1) becomes

Iₜ+F|∇I|=0, (2)

In the case of optical flow computations, since one does not know the optical flow velocity \vec{u}, it would seem that the sign of F is not available. However, from Eq. (2) it can be seen that since |∇I| is always positive, the sign of F has to be the negative of the sign of the local time derivative Iₜ. Now, one can develop upwind methods for solving for the optical flow velocity components based on the sign of F (i.e., Iₜ), which is done in the following.

An important component of an upwind method is the quantity called numerical flux. In the level set approach, originally introduced by Osher and Sethian [19], several numerical fluxes for solving Eq. (2) are mentioned. In the level set approach, the spatial gradient is typically written with respect to Cartesian coordinates. The following discussion uses the numerical flux recommended by Osher and Sethian [19] for solving Eq. (2) by way of illustration. Any of the alternate numerical flux formulations that are mentioned in Osher and Sethian [19], and Toro [20], for example, can be used instead.

For positive F, the square of the r^{th} component of the spatial gradient is evaluated as Iᵣ²=max(A,0)²+min(B,0)², where r=x,y,z for 3D and r′=x, y for 2D, A=Dᵢⱼₖ⁻¹I+0.5Δr minmod(Dᵢⱼₖ^{-r-r}I, Dᵢⱼₖ^{+r-r}I) and B=Dᵢⱼₖ^{+r}I+0.5Δr minmod(Dᵢⱼₖ^{+r+r}I, Dᵢⱼₖ^{+r-r}I), and the minmod function returns the argument with the smallest absolute value if both arguments are of the same sign and returns zero if both arguments are of opposite sign. For r=x, Dᵢⱼₖ^{-x}I=(Iᵢⱼₖ−Iᵢ₋₁ⱼₖ)/Δx, Dᵢⱼₖ^{+x}I=(Iᵢ₊₁ⱼₖ−Iᵢⱼₖ)/Δx, Dᵢⱼₖ^{-x-x}I=(Iᵢⱼₖ−2Iᵢ₋₁ⱼₖ+Iᵢ₋₂ⱼₖ)/Δx², Dᵢⱼₖ^{+x-x}I=(I_{i|1jk}−2Iᵢⱼₖ+I_{i 1jk})/Δx² and Dᵢⱼₖ^{+x+x}I=(I_{i|2jk}−2I_{i|1jk}+Iᵢⱼₖ)/Δx². For r=y, z, quantities are defined similarly. The minmod function belongs to a general family of functions called limiters and one can use other limiters in place of the minmod function, see, for example, Toro [20].

For negative F, the square of the r^{th} component of the spatial gradient is evaluated as Iᵣ²=min(A,0)²+max(B,0)². The above approximations for the image derivatives result in a second order scheme in spatial coordinates. For obtaining a first order scheme, one simply drops the use of the minmod function in the above expressions for Iᵣ². Equivalently, one could always return a zero from the minmod function.

Thus, when Iₜ is negative, one could choose the approximation Iᵣ²=max(A,0)²+min(B,0)², and when Iₜ is positive, one could choose the approximation Iᵣ²=min(A,0)²+max(B,0)² for the square of the r^{th} spatial derivative.

In many optical flow algorithms, however, one needs the actual value of the derivative along the r^{th} coordinate direction, not just its square. In the following, how to obtain the actual values of the image derivatives using an upwind discretization is disclosed for the case when Iₜ is negative. The case when Iₜ is positive is analogous.

When Iₜ is negative, one simply uses Iᵣ=max(A,0)+min(B,0). This approximation will be consistent with the level set approximation for Iᵣ² except for the shock case, which occurs when A is positive and B is negative.

It should be noted here that the exact solution of the shock case for scalar conservation laws would choose either A or B, depending upon the sign of the shock speed, see Engquist and Osher [21]. Thus, the level set approximation for the shock case is more dissipative than the exact solution.

In order to handle the shock case, one takes advantage of the fact that optical flow velocity components are typically computed in an iterative manner. Thus, one assumes that a current estimate of the optical flow velocity components is available. If the velocity component is zero along a coordinate direction in which the shock condition occurs, one could either choose A or B since the contribution along this direction is zero. Thus, only when the velocity component is non-zero one needs to analyze the case further.

Now, suppose that the shock condition occurs along only one coordinate direction and let this be the x-direction. Then, one computes the quantities α=|Iₜ+uA+vI_{y}+wI_{z}| and β=|Iₜ+uB+vI_{y}+wI_{z}|. Obviously, for 2D, one would not include the terms involving w. The correct choice for the x-derivative would be the value that corresponds to the minimum of αand β. If the shock condition occurs along more than one direction then the treatment would be exactly the same except that one would find the minimum of at most 2ⁿ quantities where n is the total number of coordinate directions along which shock condition occurs. The x, y and z derivatives corresponding to this minimum would be the corresponding derivatives, respectively, for the shock condition. One needs to consider 2ⁿ quantities only when all the velocity components are non-zero. The number of cases that need to be considered reduces by a factor of 2 for each velocity component that is zero.

The input images to the methods of this invention may be raw images obtained from field sensing devices, or processed images that apply image processing techniques to raw images, or synthetic images generated using an image generating device such as, but not limited to, a computer. The input images could also be processed images that combine images recorded with a field sensing device with synthetic images generated by an image generating device. This specification uses the term image in a generic sense to denote any of the above types of images.

Since, typically large motions are involved in optical flow computations, a common strategy used in optical flow computations is to build an image pyramid by successive coarsening of the images and then use a coarse-to-fine strategy to compute optical flow at the coarsest level first and progressively transferring this information to the next finer level. In this process, the image identified as at the current time instant is warped at each level using the optical flow computed at the previous coarse level. So, local time derivative at a pixel in this context would be the difference between the image intensities at the next time instant and the warped image at the current time instant at that pixel.

Finally, in order to compute the optical flow velocity components, the OFC module uses the upwind image derivatives calculated using the methods disclosed above, instead of calculating them using central differencing stencils, in methods such as, but not limited to, the Horn and Schunck method and the Lukas-Kanade method. Thus, several upwind optical flow methods become available.

The OFC module uses one or more of the above disclosed upwind methods to calculate the optical flow velocity components regardless of whether the optical flow is 1D or 2D or 3D or whether the images are color or grayscale. It uses same methods for calculating the velocity components in range flow problems.

The upwind methods for 1D, 2D and 3D, grayscale or color, optical flow computations as well as range flow computations need not be implemented in a single module. They can be implemented, optimized, and used separately. Indeed, this is a preferred embodiment of this specification. Obviously, a 3D OFC module can be used for solving a 1D or 2D problem if resource utilization and performance are not of concern.

The software implementation can be stored on internal storage media or on external storage media. It can also be stored in ROM or RAM. It can also be received by a computer from a remote source just before computations begin. Invocation of the implementation can be as simple as turning the power supply to the optical flow computing device on. The implementation can also be invoked via the issue of a command using a suitable peripheral device or a remote machine.

### 4.0 Optical Flow Computing Process

This section discloses a preferred optical flow computing process after the OFC module receives two images from the IO module. Note that IO module can be implemented as a sub-module within the OFC module. As shown in FIG. 6, the computations start at the first pixel 600. The first step is to calculate the local time derivative 601. Then, the sign of the local time derivative is checked to see whether it is positive or negative 602. If the sign is negative then the spatial derivatives are calculated in an upwind manner corresponding to a positive speed 603 as disclosed previously. If the sign is positive then the spatial derivative are calculated in an upwind manner corresponding to a negative speed 604 as disclosed previously. Once the spatial derivatives are calculated, a standard optical flow algorithm is used for computing the optical flow velocity components 605. Note that most standard algorithms are iterative. Then a check is performed to determine whether the last pixel is reached 606. If not 608 then the above procedure is repeated starting at step 601. If the last pixel is reached then a check is performed to see whether the optical flow has converged 607. This is typically done by taking the sum of the squares of the difference beween the flow velocity components between the current iteration and the previous iteration at each pixel and then summing over all the pixels and checking whether the sum has fallen below a pre-specified threshold. This procedure is called using the L² norm for convergence. Another popular norm for checking for convergence that can be used is the L²⁸ norm, which checks whether the maximum of the absolute difference between the velocity components at the current and previous iterations has fallen below a pre-specified threshold. If the flow has not converged then one starts at the first pixel 600 and repeats the entire procedure again. If the optical flow has converged then the flow is sent for further processing 609 by other modules, depending upon the intended application. Then, the next two images are received by the OFC modules 610 and the processing starts all over again at step 600.

It is understood that building an image pyramid and using the coarse-to-fine strategy are part of the standard algorithm for computing optical flow. Thus, computing the time derivative and the upwind discretization-based spatial derivatives has the appropriate meaning at each level of the pyramid.

Structural changes to the above disclosed process such as changing the convergence criteria, changing the upwind fluxes used, changing the order of pixel traversal, changing the standard algorithm for optical flow computation, and other similar changes are within the scope of this specification.

### LIST OF REFERENCES

[1] B. K. P. Horn, and B. G. Schunck, Determining Optical Flow, Artificial Intelligence, 17(1-3), 185-203, 1981.

[2] J. L. Barron, D. J. Fleet, and S. S. Beauchemin, Performance of optical flow techniques, International journal of Computer Vision, 12(1):43-77, 1994.

[3] A. Bruhn, J. Weickert, C. Schnörr, Lucas/Kanade meets Horn/Schunck: Combining local and global optic flow methods, International journal of Computer Vision, Vol. 61, No. 3, 211-231, February/March 2005.

[4] I. Sobel, An isotropic 3×3 image gradient operator. In H. Freeman, editor, Machine Vision for Three-Dimensional Scenes, pages 376-379. Academic Press, 1990.

[5] J. M. S. Prewitt, Object enhancement and extraction. In B. S. Lipkin and A. Rosenfeld, editors, Picture Processing and Psychopictorics. Academic Press, 1970.

[6] B. D. Lucas and T. Kanade, An Iterative Image Registration Technique with an Application to Stereo Vision, Proceedings of the 1981 DARPA Image Understanding Workshop, April, pp. 121-130, 1981.

[7] S. Sun and Y. Kim, Motion estimation within a sequence of data frames using optical flow with adaptive gradients, U.S. Pat. No. 6,480,615, Nov. 12, 2002.

[8] M. J. Black and P. Anandan, The robust estimation of multiple motions: Parametric and piecewise-smooth flow fields, Computer Vision and Image Understanding, CVIU, 63(1), pp. 75-104, January 1996.

[9] A. Borzi, K. Ito and K. Kunisch, An optimal control approach to optical flow computation, International journal for Numerical Methods in Fluids, 40, pp. 231-240, 2002.

[10] H. Sakaino, A Unified Prediction Method for Heterogeneous Weather Radar Patterns, In Proceedings of the sixth IEEE Workshop on Applications of Computer Vision (WACV'02), Orlando Fla., Dec. 3-4, 2002.

[11] N. A. Gennert and S. Negahdaripour, Relaxing the brightness constancy assumption in computing optical flow, Tech Report Memo No. 975, MIT Artificial Intelligence Laboratory, June 1987.

[12] Zientara G P, Saiviroonporn P, Morrison P R, M. P. Fried, S. G. Hushek, R. Kikinis, and F. A. Jolesz, MRI monitoring of laser ablation using optical flow. J Magn Reson Imaging 8: 1306-1318, 1998.

[13] J. L. Prince, S. N. Gupta and N. F. Osman, Bandpass optical flow for tagged MRI, Medical Physics, 27(1), 108-118, January 2000.

[14] R. Srikanth and A. G. Ramakrishnan, Contextual encoding in uniform and adaptive mesh-based lossless compression of MR images, IEEE Transactions on Medical Imaging, 24(9):1199-1206, September 2005.

[15] M. D. Abramoff and M. A. Viergever, Computation and visualization of three-dimensional soft tissue motion in the orbit, IEEE Transactions on Medical Imaging, (21)4:296-304, April 2002.

[16] E P Simoncelli. Design of multi-dimensional derivative filters. In First Int'l Conf on Image Proc, volume I, pages 790-793, Austin, Tex., November 1994.

[17] J. L. Barron, Experience with 3D optical flow on gated MRI cardiac datasets, 1st Canadian Conference on Computer and Robot Vision, May, pp 370-377, 2004.

[18] P. Golland and A. Bruckstein, Motion from Color, Computer Vision and Image Understanding, (68)3:346-362, December 1997.

[19] S. Osher and J. A. Sethian, Fronts propagating with curvature-dependent speed: Algorithms based on Hamilton-Jacobi formulations, Journal of Computational Physics, 79, 12-49, 1988.

[20] E. F. Toro, Riemann Solvers and Numerical Methods for Fluid Dynamics: A Practical Introduction, 2^{nd} ed., Springer-Verlag, 1999.

[21] B. Engquist and S. J. Osher, Stable and Entropy-Satisfying Approximations for Transonic Flow Calculations, Mathematics of Computation, 34, 45-75, 1980.

What is claimed is:

1. A process for the upwind discretization-based calculation of optical flow velocity components using an optical flow compute device, comprising of the following process actions:
receiving an image stream at the optical flow computing device;
continually selecting two images from the image stream;
identifying one of the images, for clarity, but without limitation, as the current image, and the other image, for clarity, but without limitation, as the next image;
computing the local time derivative of the image intensity field at each pixel using the current and next images;
computing the spatial derivatives of the image intensity field at each pixel using an upwind discretization, where upwinding is done based on the sign of the local time derivative of the image intensity field;
computing optical flow between the two images using a standard optical flow technique, such as, but not limited to, Horn and Schunck and Lucas and Kanade using the above computed spatial and temporal derivatives instead of the standard central-differencing based quantities.

2. The process of claim 1, where the image stream received by the optical flow compute device is generated by a physical field sensing device.

3. The process of claim 1, where the image stream received by the optical flow compute device is synthetically generated by, but not limited to, a computer, where synthetically generated image stream includes modifications, including additions and omissions, made to an image stream originally produced by a field sensing device.

4. The process of claim 1, where the image stream received by the optical flow compute device is generated by a virtual camera.

5. The process of claim 1, where the action of selecting the two images is based on a user-specified time interval, where the next image is selected after the said time interval after the current image is selected.

6. The process of claim 1, where the action of selecting the two images is based on a system-determined time interval, where the next image is selected after the said time interval after the current image is selected.

7. The process of claim 1, where the action of selecting the two images is simply accepting two consecutive images arriving at the optical flow compute device.

8. The process of claim 1, where the action of selecting the first image occurs as needed by the OFC module.

9. The process of claim 1, where the action of selecting an image includes the application of a smoothing filter such as, but not limited to, a Gaussian filter.

10. The process of claim 1, where a coarse-to-fine strategy is used for computing the optical flow velocity components with an accompanying image pyramid, where the image pyramid is constructed using a smoothing operator such as, but not limited to, Gaussian smoothing followed by subsampling.

11. The claim of 10, where the current image at each level is the warped subsample obtained from the original current image and the next image at each level is the subsample obtained from the original next image.

12. The claim of 11, where warping is applied only once.

13. The claim of 11, where warping is applied on an incremental basis using an iterative procedure.

14. The process of claim 1, where the spatial derivatives are computed using the current image, which results in an explicit scheme.

15. The process of claim 1, where the spatial derivatives are computed using the next image, which results in an implicit scheme.

16. The process of claim 1, where the spatial derivatives are computed using a combination, linear or nonlinear, of the spatial derivatives computed using the current and the next images respectively.

17. The process of claim 16, where the combination varies from pixel to pixel.

18. The process of claim 1, where the image stream received consists of only two images, which implies that continually selecting two images means selecting the two images once.

19. A system for the upwind discretization-based calculation of optical flow velocity components, said system comprising:
a field sensing device for generating at least one image stream where the image stream comprises of at least two images of the same scene recorded at slightly different times;
an optical flow compute device for computing the optical flow velocity components, using upwind discretization-based image derivatives, for a plurality of image pairs selected from the image stream;
a Camera-Computer connector for connecting the field sensing device with the optical flow compute device;
a storage device for storing the image stream and the computed optical flow velocity components;
an implementation having modules for the upwind discretization-based calculation of optical flow velocity components, said modules comprising,
An IO module that receives an image stream at the optical flow compute device and outputs the corresponding computed optical flow velocity components to other modules for further processing and/or for storage, wherein said other modules are application dependent;
A selection module that continually selects two images from the image stream and passes them to the optical flow compute module;
An optical flow compute module that uses the selected two images and computes the optical flow velocity components between them using image derivatives obtained from an upwind discretization in an optical flow algorithm.

20. The system of claim 19, wherein the image sensing device generates the image as a three-dimensional (3D) field.

21. The system of claim 19, wherein the image sensing device generates the image as a two-dimensional (2D) field on a Euclidian (flat) surface.

22. The system of claim 19, wherein the image sensing device generates the image as a two-dimensional (2D) field on a Riemannian (curved) surface.

23. The system of claim 19, wherein the image sensing device is comprised of several individual cameras (i.e., camera as defined in the Description).

24. The system of claim 19, wherein the image sensing device is comprised of a single camera (i.e., camera as defined in the Description).

25. The system of claim 19, wherein the image sensing device is a virtual camera (i.e., virtual camera as defined in the Description).

26. The system of claim 19, wherein the Camera-Computer connector connects the image sensing device with the optical flow compute device electromagnetically (wireless) and/or electronically (wired).

27. The system of claim 19, wherein the Camera-Computer connector comprises of devices such as routers, hubs, switches and repeaters.

28. The system of claim 19, wherein the optical flow compute device comprises of a general purpose computer.

29. The system of claim 19, wherein the optical flow compute device comprises of a special purpose computer.

30. The system of claim 19, wherein the optical flow compute device comprises of a general purpose computer and a special purpose computer.

31. The system of claim 19, wherein the computers share data via an electromagnetic (wireless) network.

32. The system of claim 19, wherein the computers share data via an electronic (wired) network.

33. The system of claim 19, wherein the computers share data via a network comprising of partly electromagnetic and partly electronic sub-networks.

34. The system of claim 19, wherein the storage device is external to the optical flow compute device.

35. The system of claim 19, wherein the storage device is internal to the optical flow compute device.

36. The system of claim 19, wherein the storage device is partly external and partly internal to the optical flow compute device.

37. The system of claim 19, wherein the IO module contains a compression sub-module and a decompression sub-module, wherein the decompression sub-module will be used to decompress incoming images, if needed, and the compression module will optionally, as per user or application specification, be used for compressing outgoing data.
